(19) United States
(12) Patent Application Publication
(10) Pub. No.: US 2017/0241843 A1
(43) Pub. Date: Aug. 24, 2017

(54) METHOD FOR PROVIDING TEMPERATURE INFORMATION AND ELECTRONIC DEVICE SUPPORTING THE SAME

(71) Applicant: Samsung Electronics Co., Ltd, Gyeonggi-do (KR)

(72) Inventors: Tae-Han Jeon, Gyeonggi-do (KR); Hyejung Seo, Gyeonggi-do (KR); Sun Ok Jung, Gyeonggi-do (KR); Joonho Kim, Gyeonggi-do (KR); Won Suk Choi, Seoul (KR)

(21) Appl. No.: 15/441,196

(22) Filed: Feb. 23, 2017

(30) Foreign Application Priority Data
Feb. 23, 2016 (KR) 10-2016-0021176

(51) Int. Cl. G01K 3/14; G06K 9/32; G01P 13/00; G06T 7/246

(52) U.S. Cl. CPC G01K 3/14; G06T 7/248; G06K 9/3233; G01P 13/00; G06T 2207/10024; G06T 2207/10048; G06T 2207/30201

(57) ABSTRACT

An electronic device according to various exemplary embodiments of the present disclosure includes: a motion sensor; a temperature sensor configured to acquire temperature information on an external object; an image sensor configured to acquire an image on the external object; and a processor, and the processor is configured to: identify a motion of the electronic device and a motion of the external object using the motion sensor or the image; when the motion falls within a specified range, acquire the temperature information in a first method; when the motion falls within another specified range, acquire the temperature information in a second method; and provide an indicator corresponding to the temperature information through a display functionally connected with the electronic device.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Feb. 23, 2016 and assigned Serial No. 10-2016-0021176, the contents of which are incorporated herein by reference.

### TECHNICAL FIELD

Various exemplary embodiments of the present disclosure relate to a method for providing temperature information and an electronic device supporting the same.

### BACKGROUND

Methods for measuring temperature of an external object include a contact method which measures temperature of an external object by bringing a temperature measuring device into contact with the external object, and a contactless method which absorbs infrared ray energy generated from an external object and measures temperature of the external object based on the absorbed infrared ray energy. For example, the contactless method measures temperature of an external object using one temperature sensor which absorbs infrared ray energy (for example, a thermometer), or measures temperature of an external object using a plurality of temperature sensors implemented in the form of an array (for example, a thermal camera).

### SUMMARY

The contact method has a limit to measuring temperature of an external object since the temperature is measured only when a temperature measuring device is brought into contact with the external object. The contactless method, which measures temperature using a plurality of temperature sensors implemented in the form of an array, costs much and also requires a large-size temperature measuring device. Therefore, it is difficult to apply the contactless method to small electronic devices. The contactless method which measures temperature using one temperature sensor has a limit to a temperature measuring range. In addition, when there is a motion in a temperature measuring device or an external object to be measured, it is difficult to measure temperature exactly.

To address the above-discussed deficiencies, it is a primary object to provide a method for acquiring temperature information adaptively according to a degree of a motion of an electronic device, which includes a small number of temperature sensors (for example, one temperature sensor), or a degree of a motion of an external object, or a degree of a change in temperature of the external object, and providing the temperature information, and an electronic device supporting the same.

The technical objects to be achieved by the present disclosure are not limited to the above-mentioned technical object, and other technical objects which are not mentioned herein could be obviously understood by a person skilled in the art based on the following descriptions.

An exemplary embodiment of the present disclosure may provide an electronic device. The electronic device includes: a motion sensor; a temperature sensor configured to acquire temperature information on an external object; an image sensor configured to acquire an image on the external object; and a processor. The processor may be configured to: identify a motion of the electronic device and a motion of the external object using the motion sensor or the image; when the motion falls within a specified range, acquire the temperature information in a first method; when the motion falls within another specified range, acquire the temperature information in a second method; and provide an indicator corresponding to the temperature information through a display functionally connected with the electronic device.

Another exemplary embodiment of the present disclosure may provide a method including: identifying a motion of an electronic device or a motion of an external object using an image which is acquired through an image sensor, or a motion sensor; when the motion falls within a specified range, acquiring temperature information on the external object in a first method using a temperature sensor for acquiring the temperature information on the external object; when the motion falls within another specified range, acquiring the temperature information in a second method using the temperature sensor for acquiring the temperature information on the external object; and providing an indicator corresponding to the temperature information through a display functionally connected with the electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in junction with the accompanying drawings, in which like reference numerals represent like parts:

FIG. 1 illustrates an example environment of a network including an electronic device according to various exemplary embodiments of the present disclosure;

FIG. 2 illustrates an example electronic device according to various exemplary embodiments of the present disclosure;

FIG. 3 illustrates an example program module according to various exemplary embodiments;

FIGS. 4A and 4B illustrate an example temperature sensor according to various exemplary embodiments of the present disclosure;

FIG. 5 illustrates a flowchart of a method for providing temperature information according to various exemplary embodiments of the present disclosure;

FIG. 6 illustrates an example method for providing temperature information according to various exemplary embodiments of the present disclosure;

FIG. 7 illustrates a flowchart of a method for providing temperature information according to an exemplary embodiment of the present disclosure;

FIG. 8 illustrates a flowchart of a method for providing temperature information in a spot mode according to an exemplary embodiment of the present disclosure;

FIGS. 9A and 9B illustrate an example method for providing temperature information in the spot mode according to an exemplary embodiment of the present disclosure;

FIG. 10 illustrates a flowchart of a method for providing temperature information in the spot mode according to another exemplary embodiment of the present disclosure;

FIGS. 11A and 11B illustrate an example method for providing temperature information in the spot mode according to another exemplary embodiment of the present disclosure;

FIG. 12 illustrates a flowchart of a method for providing temperature information in a scan mode according to an exemplary embodiment of the present disclosure;

FIGS. 13A to 16 illustrate an example method for providing temperature information in the scan mode according to an exemplary embodiment of the present disclosure; and

FIGS. 17A to 18F illustrate an example method for providing a guide for acquiring temperature information according to an exemplary embodiment of the present disclosure.

### DETAILED DESCRIPTION

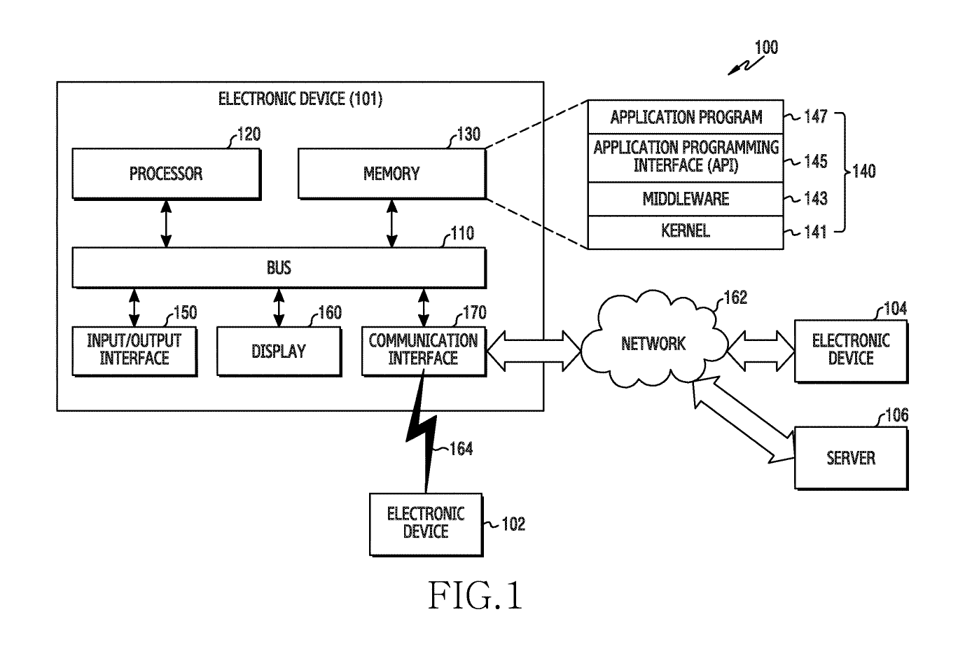

FIGS. 1 through 18F, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including both at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

FIG. 1 illustrates an example network environment including an electronic device according to various embodiments of the present disclosure.

An electronic device 101 within a network environment 100, according to various embodiments, will be described with reference to FIG. 1. The electronic device 101 may include a bus 110, a processor 120, a memory 130, an input/output interface 150, a display 160, and a communication interface 170. In some embodiments, the electronic device 101 may omit at least one of the above elements or may further include other elements.

The bus 110 may include, for example, a circuit for connecting the elements 110-170 and transferring communication (e.g., control messages and/or data) between the elements.

The processor 120 may include one or more of a central processing unit (CPU), an application processor (AP), and a communication processor (CP). The processor 120, for example, may carry out operations or data processing relating to control and/or communication of at least one other element of the electronic device 101.

The memory 130 may include a volatile memory and/or a non-volatile memory. The memory 130 may store, for example, instructions or data relevant to at least one other element of the electronic device 101. According to an embodiment, the memory 130 may store software and/or a program 140. The program 140 may include, for example, a kernel 141, middleware 143, an application programming interface (API) 145, and/or application programs (or “applications”) 147. At least some of the kernel 141, the middleware 143, and the API 145 may be referred to as an operating system (OS).

The kernel 141 may control or manage system resources (e.g., the bus 110, the processor 120, or the memory 130) used for performing an operation or function implemented by the other programs (e.g., the middleware 143, the API 145, or the application programs 147). Furthermore, the kernel 141 may provide an interface through which the middleware 143, the API 145, or the application programs 147 may access the individual elements of the electronic device 101 to control or manage the system resources.

The middleware 143, for example, may function as an intermediary for allowing the API 145 or the application programs 147 to communicate with the kernel 141 to exchange data.

In addition, the middleware 143 may process one or more operation requests received from the application program 147 according to priority. For example, the middleware 143 may give priority to use the system resources of the electronic device 101 (for example, the bus 110, the processor 120, the memory 130, and the like) to at least one of the application programs 147. For example, the middleware 143 may perform scheduling or load balancing with respect to the one or more operation requests by processing the one or more operation requests according to the priority given to the at least one application program.

The API 145 is an interface through which the applications 147 control functions provided from the kernel 141 or the middleware 143, and may include, for example, at least one interface or function (e.g., instruction) for file control, window control, image processing, or text control.

The input/output interface 150, for example, may function as an interface that may transfer instructions or data input from a user or another external device to the other element(s) of the electronic device 101. Furthermore, the input/output interface 150 may output the instructions or data received from the other element(s) of the electronic device 101 to the user or another external device.

The display 160 may include, for example, a liquid crystal display (LCD), a light emitting diode (LED) display, an organic light emitting diode (OLED) display, a micro electro mechanical system (MEMS) display, or an electronic paper display. The display 160, for example, may display various types of content (e.g., text, images, videos, icons, or symbols) for the user. The display 160 may include a touch screen and receive, for example, a touch, gesture, proximity, or hovering input using an electronic pen or the user's body part.

The communication interface 170, for example, may set communication between the electronic device 101 and an external device (e.g., the first external electronic device 102, the second external electronic device 104, or a server 106). For example, the communication interface 170 may be connected to a network 162 through wireless or wired communication to communicate with the external device (e.g., the second external electronic device 104 or the server 106).

The wireless communication may use at least one of, for example, long term evolution (LTE), LTE-Advance (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may be performed by using at least one of, for example, Wi-Fi, bluetooth, bluetooth low energy (BLE), near field communication (NFC), and global navigation satellite system (GNSS). The GNSS may include at least one of, for example, a global positioning system (GPS), a global navigation satellite system (Glonass), a beidou navigation satellite system (hereinafter referred to as “Beidou”), and a european global satellite-based navigation system (Galileo), according to a use area, a bandwidth, or the like. Hereinafter, in the present disclosure, the “GPS” may be interchangeably used with the “GNSS”. The wired communication may include at least one of, for example, a universal serial bus (USB), a high definition multimedia interface (HDMI), recommended standard 232 (RS-232), and a plain old telephone service (POTS). The network 162 may include at least one of a communication network such as a computer network (e.g., a LAN or a WAN), the Internet, and a telephone network.

Each of the first and second external electronic apparatuses 102 and 104 may be of a type identical to or different from that of the electronic apparatus 101. According to an embodiment, the server 106 may include a group of one or more servers. According to various embodiments, all or some of the operations performed in the electronic device 101 may be performed in another electronic device or a plurality of electronic devices (e.g., the electronic devices 102 and 104 or the server 106). According to an embodiment, when the electronic device 101 has to perform some functions or services automatically or in response to a request, the electronic device 101 may make a request for performing at least some functions relating thereto to another device (e.g., the electronic device 102 or 104 or the server 106) instead of performing the functions or services by itself or in addition. Another electronic apparatus may execute the requested functions or the additional functions, and may deliver a result of the execution to the electronic apparatus 101. The electronic device 101 may process the received result as it is or additionally to provide the requested functions or services. To achieve this, for example, cloud computing, distributed computing, or client-server computing technology may be used.

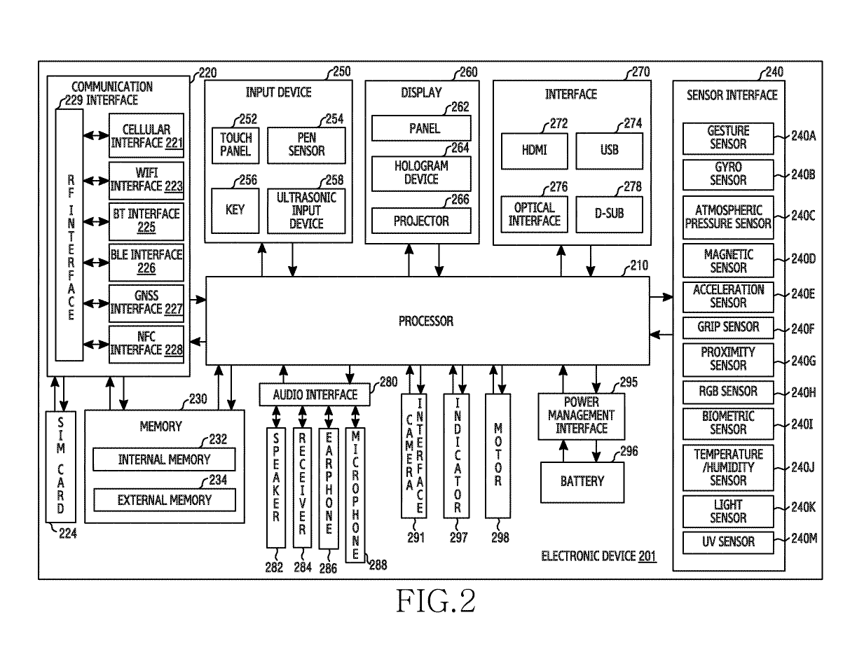

FIG. 2 illustrates an example electronic device according to various embodiments of the present disclosure.

FIG. 2 illustrates an example electronic device 201 according to various embodiments. For example, the electronic apparatus 201 may include the whole or part of the electronic apparatus 101 illustrated in FIG. 1. The electronic device 201 may include at least one processor (e.g., application processor (AP)) 210, a communication interface 220, a subscriber identification module (SIM) 224, a memory 230, a sensor 240, an input device 250, a display 260, an interface 270, an audio 280, a camera 291, a power management 295, a battery 296, an indicator 297, and a motor 298.

The processor 210 may control a plurality of hardware or software components connected to the processor 210 by driving an operating system or an application program and perform processing of various pieces of data and calculations. The processor 210 may be implemented by, for example, a system on chip (SoC). According to an embodiment, the processor 210 may further include a graphic processing unit (GPU) and/or an image signal processor. The processor 210 may include at least some (e.g., a cellular interface 221) of the elements illustrated in FIG. 2. The processor 210 may load, into a volatile memory, instructions or data received from at least one (e.g., a non-volatile memory) of the other elements and may process the loaded instructions or data, and may store various data in a non-volatile memory.

The communication interface 220 may have a configuration equal or similar to that of the communication interface 170 of FIG. 1. The communication interface 220 may include, for example, the cellular interface 221, a Wi-Fi interface 223, a Bluetooth (BT) module 225, a Bluetooth low energy module 226, a GNSS interface 227 (e.g., a GPS interface, a Glonass interface, a Beidou interface, or a Galileo interface), an NFC interface 228, and a radio frequency (RF) 229.

The cellular interface 221 may provide a voice call, image call, a text message service, or an Internet service through, for example, a communication network. According to an embodiment, the cellular interface 221 may distinguish between and authenticate electronic devices 201 within a communication network using a subscriber identification module (for example, the SIM card 224). According to an embodiment of the present disclosure, the cellular interface 221 may perform at least some of the functions that the processor 210 may provide. According to an embodiment, the cellular interface 221 may include a communication processor (CP).

Each of the Wi-Fi 223, the BT interface 225, the Bluetooth low energy interface 226, the GNSS interface 227, and the NFC interface 228 may include, for example, a processor for processing data transmitted and received through the relevant module. According to some embodiments of the present disclosure, at least some (e.g., two or more) of the cellular interface 221, the Wi-Fi interface 223, the BT interface 225, the GNSS interface 227, and the NFC interface 228 may be included in one integrated chip (IC) or IC package.

The RF 229 may transmit/receive, for example, a communication signal (for example, an RF signal). The RF 229 may include, for example, a transceiver, a power amplifier module (PAM), a frequency filter, a low noise amplifier (LNA), and an antenna. According to another embodiment of the present disclosure, at least one of the cellular interface 221, the Wi-Fi interface 223, the BT interface 225, the Bluetooth low energy interface 226, the GNSS interface 227, and the NFC interface 228 may transmit and receive RF signals through a separate RF.

The subscriber identification module 224 may include, for example, a card including a subscriber identity module and/or an embedded SIM, and may contain unique identification information (e.g., an integrated circuit card identifier (ICCID)) or subscriber information (e.g., an international mobile subscriber identity (IMSI)).

The memory 230 (for example, the memory 130) may include, for example, an internal memory 232 or an external memory 234. The embedded memory 232 may include at least one of a volatile memory (for example, a dynamic random access memory (DRAM), a static RAM (SRAM), a synchronous dynamic RAM (SDRAM), and the like) and a non-volatile memory (for example, a one time programmable read only memory (OTPROM), a programmable ROM (PROM), an erasable and programmable ROM (EPROM), an electrically erasable and programmable ROM (EEPROM), a mask ROM, a flash ROM, a flash memory (for example, a NAND flash memory or a NOR flash memory), a hard disc drive, a solid state drive (SSD), and the like).

The external memory 234 may further include a flash drive, for example, a compact flash (CF), a secure digital (SD), a micro secure digital (Micro-SD), a mini secure digital (Mini-SD), an extreme digital (xD), a memory stick, or the like. The external memory 234 may be functionally and/or physically connected to the electronic apparatus 201 through various interfaces.

The sensor 240 may measure a physical quantity or detect an operation state of the electronic device 201, and may convert the measured or detected information into an electrical signal. For example, the sensor 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red/green/blue (RGB) sensor), a bio-sensor 240I, a temperature/humidity sensor 240J, a light sensor 240K, and an ultra violet (UV) sensor 240M. In one embodiment, the temperature/humidity sensor 240J may be included in the camera 291. In one embodiment, the temperature/humidity sensor 240J may be combined with an image sensor of the camera 291 as one module. In one embodiment, the temperature/humidity sensor 240J may be a component independent from the image sensor. Additionally or alternatively, the sensor 240 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor 240 may further include a control circuit for controlling one or more sensors included therein. In some embodiments of the present disclosure, the electronic apparatus 201 may further include a processor configured to control the sensor 240 as a part of or separately from the processor 210, and may control the sensor 240 while the processor 210 is in a sleep state.

The input device 250 may include, for example, a touch panel 252, a (digital) pen sensor 254, a key 256, or an ultrasonic input device 258. The touch panel 252 may use at least one of, for example, a capacitive type, a resistive type, an infrared type, and an ultrasonic type. Also, the touch panel 252 may further include a control circuit. The touch panel 252 may further include a tactile layer and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect ultrasonic wavers generated by an input tool through a microphone (for example, a microphone 288) and identify data corresponding to the detected ultrasonic waves.

The display 260 (for example, the display 160) may include a panel 262, a hologram device 264 or a projector 266. The panel 262 may include a configuration that is identical or similar to the display 160 illustrated in FIG. 1. The panel 262 may be implemented to be, for example, flexible, transparent, or wearable. The panel 262 and the touch panel 252 may be implemented as one module. The hologram 264 may show a three dimensional image in the air by using an interference of light. The projector 266 may display an image by projecting light onto a screen. The screen may be located, for example, inside or outside the electronic apparatus 201. According to an embodiment, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio 280 may bilaterally convert, for example, a sound and an electrical signal. At least some elements of the audio 280 may be included in, for example, the input/output interface 145 illustrated in FIG. 1. The audio 280 may process sound information which is input or output through, for example, a speaker 282, a receiver 284, earphones 286, the microphone 288 or the like.

The camera 291 is a device which may photograph a still image and a dynamic image. According to an embodiment, the camera 291 may include one or more image sensors (for example, a front sensor or a back sensor), a lens, an image signal processor (ISP) or a flash (for example, LED or xenon lamp).

The power management 295 may manage, for example, power of the electronic device 201. According to an embodiment, the power management 295 may include a power management integrated circuit (PMIC), a charger integrated circuit (IC), or a battery or fuel gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature during the charging. The battery 296 may include, for example, a rechargeable battery or a solar battery.

The indicator 297 may display a particular state (e.g., a booting state, a message state, a charging state, or the like) of the electronic apparatus 201 or a part (e.g., the processor 210). The motor 298 may convert an electrical signal into mechanical vibration, and may generate vibration, a haptic effect, or the like. Although not illustrated, the electronic apparatus 201 may include a processing unit (e.g., a GPU) for supporting a mobile television (TV). The processing unit for supporting mobile TV may, for example, process media data according to a certain standard such as digital multimedia broadcasting (DMB), digital video broadcasting (DVB), or mediaFLO™.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

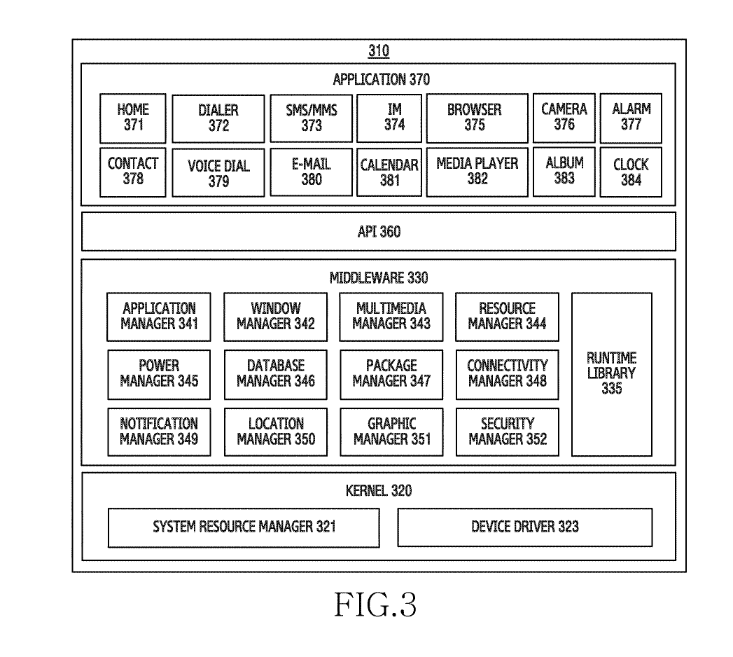

FIG. 3 illustrates an example program module according to various embodiments of the present disclosure.

According to an embodiment, the program module 310 (for example, the program 140) may include an operating system (OS) for controlling resources related to the electronic device (for example, the electronic device 101) and/or various applications (for example, the application programs 147) executed in the operating system. The operating system may be, for example, Android, iOS, Windows, Symbian, Tizen, Bada, or the like.

The program module 310 may include a kernel 320, middleware 330, an API 360, and/or an application 370. At least some of the program module 310 may be preloaded on the electronic apparatus, or may be downloaded from an external electronic apparatus (e.g., the electronic apparatus 102 or 104, or the server 106).

The kernel 320 (e.g., the kernel 141) may include, for example, a system resource manager 321 and/or a device driver 323. The system resource manager 321 may perform the control, allocation, retrieval, or the like of system resources. According to an embodiment of the present disclosure, the system resource manager 321 may include a process manager, a memory manager, a file system manager, or the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

The middleware 330 may provide a function required by the applications 370 in common or provide various functions to the applications 370 through the API 360 so that the applications 370 can efficiently use limited system resources within the electronic device. According to an embodiment, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while the applications 370 are being executed. The runtime library 335 may perform input/output management, memory management, the functionality for an arithmetic function, or the like.

The application manager 341 may manage, for example, the life cycle of at least one of the applications 370. The window manager 342 may manage graphical user interface (GUI) resources used for the screen. The multimedia manager 343 may determine a format required to reproduce various media files, and may encode or decode a media file by using a coder/decoder (codec) appropriate for the relevant format. The resource manager 344 may manage resources, such as a source code, a memory, a storage space, and the like of at least one of the applications 370.

The power manager 345 may operate together with a basic input/output system (BIOS) to manage a battery or power and may provide power information required for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection such as, for example, Wi-Fi or Bluetooth. The notification manager 349 may display or notify of an event, such as an arrival message, an appointment, a proximity notification, and the like, in such a manner as not to disturb the user. The location manager 350 may manage location information of the electronic apparatus. The graphic manager 351 may manage a graphic effect, which is to be provided to the user, or a user interface related to the graphic effect. The security manager 352 may provide various security functions required for system security, user authentication, and the like. According to an embodiment of the present disclosure, when the electronic apparatus (e.g., the electronic apparatus 101) has a telephone call function, the middleware 330 may further include a telephony manager for managing a voice call function or a video call function of the electronic apparatus.

The middleware 330 may include a middleware module that forms a combination of various functions of the above-described elements. The middleware 330 may provide a module specialized for each type of OS in order to provide a differentiated function. Also, the middleware 330 may dynamically delete some of the existing elements, or may add new elements.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (for example, the application program 147) may include, for example, one or more applications which can provide functions such as home 371, dialer 372, SMS/MMS 373, Instant Message (IM) 374, browser 375, camera 376, alarm 377, contacts 378, voice dialer 379, email 380, calendar 381, media player 382, album 383, clock 384, health care (for example, measure exercise quantity or blood sugar), or environment information (for example, atmospheric pressure, humidity, or temperature information).

According to an embodiment of the present disclosure, the applications 370 may include an application (hereinafter, referred to as an “information exchange application” for convenience of description) supporting information exchange between the electronic apparatus (e.g., the electronic apparatus 101) and an external electronic apparatus (e.g., the electronic apparatus 102 or 104). The application associated with information exchange may include, for example, a notification relay application for forwarding specific information to an external electronic device, or a device management application for managing an external electronic device.

For example, the notification relay application may include a function of delivering, to the external electronic apparatus (e.g., the electronic apparatus 102 or 104), notification information generated by other applications (e.g., an SMS/MMS application, an email application, a health care application, an environmental information application, etc.) of the electronic apparatus 101. Further, the notification relay application may receive notification information from, for example, an external electronic device and provide the received notification information to a user.

The device management application may manage (for example, install, delete, or update), for example, a function for at least a part of the external electronic device (for example, the electronic device 102 or 104) communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

According to an embodiment, the applications 370 may include applications (for example, a health care application of a mobile medical appliance or the like) designated according to attributes of the external electronic device 102 or 104. According to an embodiment of the present disclosure, the application 370 may include an application received from the external electronic apparatus (e.g., the server 106, or the electronic apparatus 102 or 104). According to an embodiment of the present disclosure, the application 370 may include a preloaded application or a third party application which can be downloaded from the server. Names of the elements of the program module 310, according to the above-described embodiments of the present disclosure, may change depending on the type of OS.

According to various embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

The module or the program module, according to various embodiments, may: include one or more elements described above; exclude some of them; or further include other elements. The operations performed by the module, the program module, or other elements, according to various embodiments, may be executed in a sequential, parallel, iterative, or heuristic method. In addition, some operations may be executed in a different order, or may be omitted, or other operations may be added. In addition, the embodiments disclosed in the present document are intended for the explanation and understanding of the technical matter, and shall not limit the scope of the technology described in the present document. Accordingly, the scope of the present disclosure should be construed to encompass all modifications or various other embodiments based on the technical concept of the present disclosure.

In addition, the embodiments disclosed in the present document are intended for the explanation and understanding of the disclosed technical matter, and shall not limit the scope of various embodiments of the present document. Therefore, the scope of various embodiments of the present document should be construed to encompass all modifications or various other embodiments based on the technical concept of the various embodiments of the present disclosure.

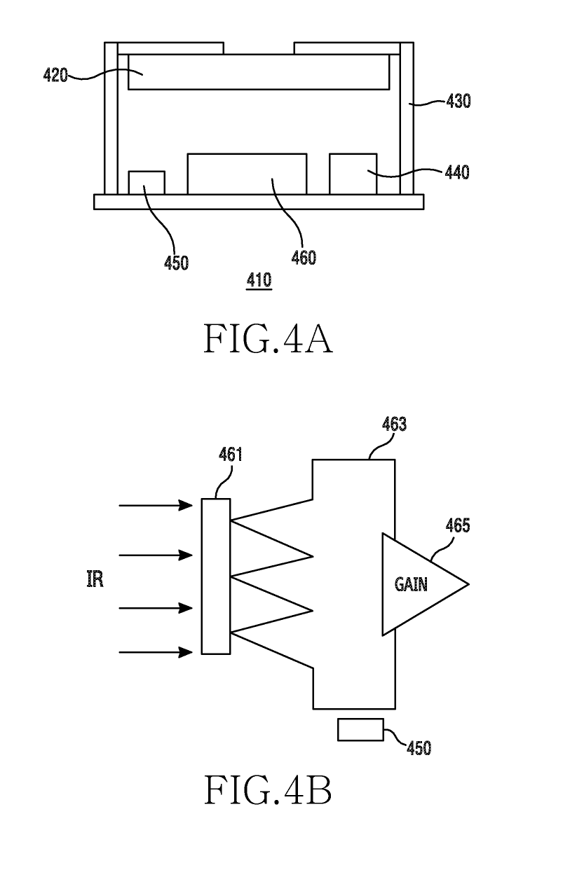

FIGS. 4A and 4B illustrate an example temperature sensor according to various exemplary embodiments of the present disclosure.

Referring to FIGS. 4A and 4B, the temperature sensor 410 according to an exemplary embodiment may include a filter 420, a package 430, a thermistor 450, a thermopile 460, and an application specific integrated circuit (ASIC) 440. According to various exemplary embodiments, the temperature sensor 410 may have the same or similar configuration as or to that of the temperature/humidity sensor 240J of FIG. 2. According to various exemplary embodiments, the temperature sensor 410 may be included in the temperature/humidity sensor 240J of FIG. 2 (or configured as one module), or may be a separate (or independent) configuration from the temperature/humidity sensor 240J. In one embodiment, when the temperature sensor 410 is implemented as a separate configuration from the temperature/humidity sensor 240J, the temperature/humidity sensor 240J may be omitted. In one embodiment, the temperature sensor 410 may be configured as a part of an image sensor of the camera 291. In one embodiment, the temperature sensor 410 may be a contactless temperature sensor. However, this should not be considered as limiting.

In one embodiment, the temperature sensor 410 may acquire temperature information using infrared rays received (or entering) from the periphery of the electronic device 101 including an external object. However, this should not be considered as limiting. For example, various exemplary embodiments of the present disclosure may use other types of light that enable acquiring ambient temperature information in addition to the infrared rays.

In one embodiment, the filter 420 may selectively transmit (or absorb) infrared rays from among the lights received from the outside. For example, the filter 420 may selectively transmit only infrared rays having wavelengths of 4-20 μm from among the lights received from the outside. In one embodiment, the filter 420 may be implemented using silica (Si), germanium (Ge), or the like. However, this should not be considered as limiting.

In one embodiment, the package 430 may support configurations included in the temperature sensor 410 and may block temperature received from the outside. In one embodiment, the package 430 may be formed of metal in order to maintain thermal equilibrium with the outside. However, this should not be considered as limiting.

In one embodiment, the ASIC 440 may amplify an analogue temperature signal received from the thermistor 450 and the thermopile 460, and convert the analogue temperature signal into a digital signal. In one embodiment, the ASIC 440 may calculate temperature of an external object based on the converted digital signal.

In one embodiment, the thermistor 450 may measure internal temperature (or temperature at a cold junction) of the temperature sensor 410. In one embodiment, the internal temperature (or temperature at the cold junction) of the temperature sensor 410 may be measured in other methods in addition to the thermistor 450.

In one embodiment, the thermopile 460 may absorb infrared rays received from the outside and convert information on the absorbed infrared rays into an electric signal.

In one embodiment, the temperature sensor 410 may acquire temperature of an external object using the seebeck effect. For example, in FIG. 4B, infrared rays transmitted through the filter 420 may be absorbed into a heat absorber 461 of the thermopile 460. The temperature of the hot junction of an element 463 increases due to the infrared rays absorbed into the heat absorber 461, and an electromotive force may be generated between the hot junction and the cold junction as an electron placed at the hot junction moves (or spreads) to the cold junction of the element 463. In one embodiment, the temperature sensor 410 may calculate a difference in temperature between the hot junction and the cold junction using the generated electromotive force. In one embodiment, the temperature sensor 410 may calculate the temperature at the hot junction of the element 463 using the temperature at the cold junction measured by the thermistor 450 and the difference in the temperature between the hot junction and the cold junction. In one embodiment, an amplifier 465 may amplify a signal on the temperature at the hot junction of the element. In one embodiment, the temperature sensor 410 may acquire (or calculate) temperature information of the external object based on the temperature at the hot junction. In one embodiment, the element 463 may be implemented by using dissimilar metal or a semiconductor, and a plurality of elements may be used to acquire temperature information. FIG. 4B illustrates a method for acquiring temperature information of an external object using the seebeck effect. However, this should not be considered as limiting, and the temperature information of the external object may be acquired using various methods.

In one embodiment, the temperature sensor 410 may be included in the camera as at least a part of the camera 291. In another embodiment, the temperature sensor 410 may be included in the electronic device 101 as a separate configuration from the camera 291.

According to various exemplary embodiments of the present disclosure, an electronic device may include: a motion sensor; a temperature sensor configured to acquire temperature information on an external object; an image sensor configured to acquire an image on the external object; and a processor. The processor may be configured to: identify a motion of the electronic device and a motion of the external object using the motion sensor or the image; when the motion falls within a specified range, acquire the temperature information in a first method; when the motion falls within another specified range, acquire the temperature information in a second method; and provide an indicator corresponding to the temperature information through a display functionally connected with the electronic device.

In one embodiment, the temperature sensor and the image sensor may be implemented by using a single module.

In one embodiment, the temperature sensor may be configured to acquire temperature information within a view area corresponding to the image sensor.

In one embodiment, the image may include a first image and a second image, and the processor may further be configured to further identify the motion based on a displacement of a pixel area corresponding to at least a part of the identified external object using the first image and the second image.

In one embodiment, the processor may further be configured such that the first method acquires the temperature information using a first sampling rate, and the second method acquires the temperature information using a second sampling rate.

In one embodiment, the processor may further be configured to further change the first sampling rate or the second sampling rate based on a change in the temperature information.

In one embodiment, the second sampling rate may include a third sampling rate and a fourth sampling rate, and the processor may further be configured to, when the motion is a first motion, change the second sampling rate to the third sampling rate, and, when the motion is a second motion, change the second sampling rate to the fourth sampling rate.

In one embodiment, the indicator may include a text indicating the temperature information or other images.

In one embodiment, the other images may include a color image corresponding to the temperature information.

In one embodiment, the processor may further be configured to display at least a part of the image and the indicator all together.

In one embodiment, the processor may further be configured to superimpose and display the other images on an area in the image corresponding to the external object.

In one embodiment, the processor may further be configured to change at least a part of the image based on an attribute corresponding to the temperature information and display the image.

In one embodiment, the external object may include a first part and a second part, and the processor may further be configured to acquire a first temperature on the first part when the electronic device is located on a first location, and acquire a second temperature on the second part when the electronic device is located on a second location.

In one embodiment, the other images may include a first area corresponding to the first part and a second area corresponding to the second part, and the processor may further be configured to display a first color corresponding to the first temperature on the first area, and display a second color corresponding to the second temperature on the second area.

In one embodiment, the processor may further be configured to determine the first area based on the first location and determine the second area based on the second location.

In one embodiment, the processor may further be configured to acquire the temperature information by moving the temperature sensor when the temperature information is acquired in the first method.

In one embodiment, the processor may further be configured to display a guide for guiding to acquire temperature information on the external object through the display.

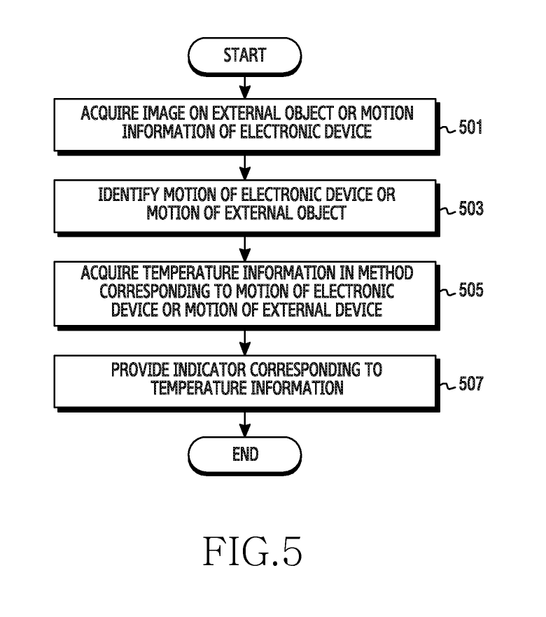

FIG. 5 illustrates a flowchart of a method for providing temperature information according to various exemplary embodiments of the present disclosure.

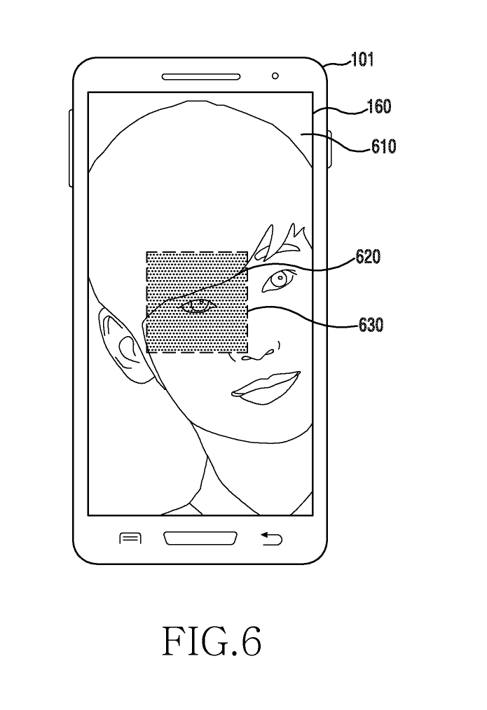

FIG. 6 illustrates an example method for providing temperature information according to various exemplary embodiments of the present disclosure.

Referring to FIGS. 5 and 6, in operation 501, the electronic device (for example, the processor 120) may acquire an image on an external object or information on a motion of the electronic device 101.

In one embodiment, the electronic device (for example, the processor 120) may acquire an image on an external object using the activated camera 291 (for example, an image sensor). For example, the electronic device (for example, the processor 120) may acquire an image on an external object at specified intervals using the camera 291. In one embodiment, the electronic device (for example, the processor 120) may store the image on the external object which is acquired at the specified intervals in the memory 130. In one embodiment, the electronic device (for example, the processor 120) may display the image on the external object which is acquired at the specified intervals in the form of a preview. However, this should not be considered as limiting.

In another embodiment, the electronic device (for example, the processor 120) may acquire information on the motion of the electronic device 101 using a motion sensor, for example, at least one of the acceleration sensor 240E, the gyro sensor 240B, the geomagnetic sensor, and the magnetic sensor 240D. In one embodiment, the electronic device (for example, the processor 120) may acquire coordinates information according to the motion of the electronic device 101 (for example, coordinates information indicating the location and the direction of the electronic device 101) at specified time intervals using the motion sensor. In one embodiment, the electronic device (for example, the processor 120) may store the coordinates information according to the motion of the electronic device 101 which is acquired at the specified time intervals in the memory 130.

In still another embodiment, the electronic device (for example, the processor 120) may acquire the information on the motion of the electronic device 101 using the motion sensor at the same time as acquiring the image on the external object using the camera 291.

In one embodiment, operation 501 may further include an operation of acquiring an image (hereinafter, referred to as a “reference image”) corresponding to (or to match) an indicator corresponding to temperature information. In one embodiment, the electronic device (for example, the processor 120) may acquire the reference image based on at least a user photographing input. The reference image will be described in detail below with reference to operation 507.

In operation 503, the electronic device (for example, the processor 120) may identify the motion of the electronic device 101 or the motion of the external object.

In one embodiment, the electronic device (for example, the processor 120) may identify the degree of the motion of the electronic device 101 or the degree of the motion of the external object (or a degree of a change in the motion) based on at least the image acquired through the camera 291. For example, the electronic device (for example, the processor 120) may identify the degree of the motion of the electronic device 101 or the degree of the motion of the external object based on at least an amount of change of pixel information of an image frame (or a displacement of a pixel area) which is acquired at specified intervals (or specified frame per second (FPS)). In one embodiment, the degree of the motion of the electronic device 101 or the degree of the motion of the external object may include a degree of a change in at least one of a motion speed, a motion acceleration, and a motion direction of the electronic device 101 or the external object.

In another embodiment, the electronic device (for example, the processor 120) may identify the degree of the motion of the electronic device 101 based on at least the information on the motion of the electronic device 101 acquired using the motion sensor. For example, the electronic device (for example, the processor 120) may identify a degree of a change in at least one of the motion speed, the motion acceleration, and the motion direction of the electronic device 101 using the motion sensor. In another example, the electronic device (for example, the processor 120) may identify the degree of the motion of the electronic device 101 based on at least a degree of a change in the coordinates information according to the motion of the electronic device 101 (for example, coordinates information indicating the location and the direction of the electronic device 101), which is acquired at specified intervals using the motion sensor.

In one embodiment, although not shown in operation 503, operation 503 may further include an operation of identifying a degree of a change in the temperature of the external object based on at least temperature information on the external object which is acquired through the temperature sensor. For example, when the temperature information on the external object is acquired at specified intervals through the activated temperature sensor, the electronic device (for example, the processor 120) may identify an amount of change in the temperature information on the external object. However, this should not be considered as limiting.

In one embodiment, the motion of the electronic device 101 or the motion of the external object may include a relative motion between the electronic device 101 and the external object. For example, when the electronic device 101 and the external device move in the same direction and at the same speed (for example, at the same acceleration), the electronic device (for example, the processor 120) may determine that there is no motion of the electronic 101 or motion of the external object. However, this should not be considered as limiting.

In operation 505, the electronic device (for example, the processor 120) may acquire temperature information in a method corresponding to the motion of the electronic device 101 or the motion of the external object.

In one embodiment, the electronic device (for example, the processor 120) may adjust a time interval (hereinafter, referred to as a “sampling rate”) at which the temperature information on the external object is acquired using the temperature sensor, according to the degree of the motion of the electronic device 101 or the degree of the motion of the external object. For example, when the degree of the motion of the electronic device 101 or the degree of the motion of the external object is great, for example, when the electronic device 101 or the external object moves at a high speed (or at a high acceleration or changes a direction rapidly), the electronic device (for example, the processor 120) may apply a high sampling rate in comparison to a case in which the electronic device 101 or the external object moves at a low speed (or at a low acceleration or changes a direction slowly).

In one embodiment, the electronic device (for example, the processor 120) may change a driving state of the motion sensor according to the degree of the motion of the electronic device 101 or the degree of the motion of the external object. For example, when it is determined that the degree of the motion of the electronic device 101 or the degree of the motion of the external object is less than a specified value (or a threshold value) in a state in which the motion sensor is activated, the electronic device (for example, the processor 120) may deactivate the activated motion sensor. In another example, when it is determined that the degree of the motion of the electronic device 101 or the degree of the motion of the external object is less than the specified value (or the threshold value) in a state in which the motion sensor is deactivated, the electronic device (for example, the processor 120) may maintain the state of the deactivated motion sensor. In still another embodiment, when it is determined that the degree of the motion of the electronic device 101 or the degree of the motion of the external object is greater than or equal to the specified value (or the threshold value) (or is changed by the specified value or more) in the state in which the motion sensor is deactivated, the electronic device (for example, the processor 120) may activate the deactivated motion sensor. However, this should not be considered as limiting.

In one embodiment, operation 505 may further include an operation of adjusting the sampling rate based on at least a change in the temperature information. For example, the electronic device (for example, the processor 120) may adjust the sampling rate based on at least a change in the acquired temperature information. For example, as the change in the temperature information on the external object, which is a target for acquiring temperature information, is greater, for example, as the temperature of at least a part of the external object, which is a target for acquiring temperature information, is changed greatly while the temperature information is acquired, the electronic device (for example, the processor 120) may apply a high sampling rate. In another example, as the change in the temperature information on the external object, which is a target for acquiring temperature information, is smaller, for example, as the temperature of at least a part of the external object, which is a target for acquiring temperature information, is changed slightly, or it is determined that there is no change in the temperature while the temperature information is acquired, the electronic device (for example, the processor 120) may apply a low sampling rate. However, this should not be considered as limiting.

In one embodiment, the electronic device (for example, the processor 120) may acquire the temperature information of the external object according to the motion of the electronic device 101. For example, FIG. 6 illustrates a view showing an example of a display 160 displaying an image which is acquired using the camera 291 and an area on which temperature is acquired using the temperature sensor. In one embodiment, a field of view of the temperature sensor may be smaller than an angle of view of the camera 291. When the field of view of the temperature sensor is smaller than the angle of view of the camera 291, the size of an area 620 on which temperature is acquired using the temperature sensor (hereinafter, “a temperature acquisition area” or “a specified view area”) may be smaller than the size (or area) of an image 610 acquired using the camera 291. In one embodiment, when the field of view of the temperature sensor is smaller than the angle of view of the camera 291, the electronic device (for example, the processor 120) may acquire temperature information of at least a part of the external object corresponding to (or included in) the temperature acquisition area which moves according to the motion of the electronic device 101. In one embodiment, FIG. 6 illustrates a boundary line 630 of the temperature acquisition area 620 (or a guide for acquiring temperature) in a dashed box. However, this should not be considered as limiting. For example, the boundary line 630 of the temperature acquisition area 620 may not be displayed on the display 160. In another example, the boundary line 630 of the temperature acquisition area 620 may be selectively displayed on the display 160 or not be displayed according to a user's input.

In one embodiment, the electronic device (for example, the processor 120) may further acquire information on the motion of the electronic device 101 and the motion of the external object in addition to the temperature information of the external object according to the motion of the electronic device 101 or the external object. For example, when the degree of the motion of the electronic device 101 or the degree of the motion of the external object is greater than or equal to a specified value (or a threshold value), the electronic device (for example, the processor 120) may acquire information on coordinates of the temperature acquisition area which is moved by a relative motion between the electronic device 101 and the external object, and simultaneously may acquire temperature information on the coordinates of the moved temperature acquisition area. In one embodiment, the electronic device (for example, the processor 120) may map information on time at which the temperature information is acquired, information on coordinates of the temperature acquisition area moved by the relative motion between the electronic device 101 and the external object, which is acquired at the time when the temperature information is acquired, and the acquired temperature information, and may store the mapped information in the memory 130. However, this should not be considered as limiting.

In operation 507, the electronic device (for example, the processor 120) may provide an indicator corresponding to the acquired temperature information.

In one embodiment, the electronic device (for example, the processor 120) may acquire temperature information at specified time intervals according to a currently set (or currently adjusted) sampling rate while the temperature acquisition area is moved according to the motion of the electronic device 101 or the external object. The electronic device (for example, the processor 120) may generate indicators indicating a plurality of pieces of temperature information based on at least the information on the motion of the electronic device 101 or the motion of the external object which is acquired using the motion sensor or the camera 291, and information on the relative motion between the electronic device 101 and the external object. For example, the electronic device (for example, the processor 120) may combine a plurality of pieces of temperature information which are mapped onto coordinates information of locations to which the temperature acquisition area is moved according to the relative motion between the electronic device 101 and the external object, and are stored. The electronic device (for example, the processor 120) may generate an indicator indicating temperature information which is mapped onto the entirety of the coordinates of the locations to which the temperature acquisition area is moved. For example, the electronic device (for example, the processor 120) may generate a plurality of pixels based on at least the coordinates of the locations to which the temperature acquisition area is moved, and generate an indicator by matching temperature information which is mapped onto the coordinates of the locations to which the temperature acquisition area is moved and is stored with the plurality of pixels.

In one embodiment, the indicator may include a text indicating temperature information (for example, a number indicating temperature) or other images. For example, the other images may include a color image (or a thermal image) which is specified according to temperature information. In another example, the other images may include an icon, a graph, or an image including a text indicating temperature information, or a combination thereof. However, this should not be considered as limiting.

In one embodiment, the electronic device (for example, the processor 120) may generate an indicator corresponding to the temperature information which is acquired at specified intervals, and display the generated indicator through the display 160 at specified intervals. For example, the electronic device may provide an indicator indicating temperature information which is acquired in real time in the temperature acquisition area which is moved according to the motion of the electronic device 101 or the motion of the external object. In one embodiment, when the indicator indicating the temperature information acquired in real time is provided, the electronic device (for example, the processor 120) may superimpose (or overlay) a preview on the external object which is acquired through the camera 291 in real time on the indicator indicating the temperature information. In another embodiment, the electronic device (for example, the processor 120) may display the indicator indicating the temperature information on an area separate from the preview on the external object which is acquired through the camera 291 in real time. However, this should not be considered as limiting. For example, the electronic device (for example, the processor 120) may provide only the indicator indicating the temperature information, which is acquired in real time, without providing the preview of the external object.

In one embodiment, the electronic device (for example, the processor 120) may provide the indicator based on at least an adjusted sampling rate. For example, the electronic device (for example, the processor 120) may update the indicator corresponding to the temperature information according to a frequency corresponding to the sampling rate, and display the updated indicator.

In one embodiment, when a reference image is acquired, the electronic device (for example, the processor 120) may provide an indicator corresponding to (or mapped onto) the reference image. For example, the electronic device (for example, the processor 120) may provide the indicator corresponding to the reference image by combining temperature information acquired in an area corresponding to the reference image, for example, an area included in a photographing area in which the reference image is acquired in the area in which temperature is acquired (or an area overlapping the photographing area in which the reference image is acquired). However, this should not be considered as limiting.

In one embodiment, the electronic device (for example, the processor 120) may provide only the indicator corresponding to the reference image or provide the indicator corresponding to the reference image and superimposed on the reference image, selectively, based on a user's input. However, this should not be considered as limiting.

In one embodiment, the electronic device (for example, the processor 120) may change at least a part of the image acquired through the camera 291 based on an attribute (for example, a color) corresponding to the temperature information, and display the image. For example, when the acquired temperature is 25° C., the electronic device (for example, the processor 120) may apply a color to at least a part of the acquired image and display the image. However, the attribute is not limited to a color. For example, the attribute may include a shape which is formed by combining lines in addition to the color. In one embodiment, the electronic device (for example, the processor 120) may further display a text corresponding to the temperature information, for example, “25° C.”, as an indicator.

Although not shown in FIG. 5, various exemplary embodiments described in FIG. 5 may further include an operation of executing, by the electronic device (for example, the processor 120), an application. In one embodiment, the application may include a camera application. The electronic device (for example, the processor 120) may activate the camera 291 in response to a user input for executing the camera application being received.

In one embodiment, when the camera application is executed, the electronic device (for example, the processor 120) may activate the temperature sensor for acquiring temperature information of an external object.

In addition, although not shown in FIG. 5, various exemplary embodiments described in FIG. 5 may further include an operation of selecting whether to acquire temperature information or not. For example, the electronic device (for example, the processor 120) may output a screen (or a user interface) for selecting, by a user, whether to measure temperature of an external object (or an external object or a surrounding environment of the external object) using the temperature sensor. In one embodiment, when an input of selecting to acquire temperature information of the external object is received from the user, the electronic device (for example, the processor 120) may activate the temperature sensor and acquire temperature information using the activated temperature sensor. In another embodiment, when an input of selecting to acquire only an image using the activated camera 291 (or image sensor) without acquiring temperature information of the external object is received from the user, the electronic device (for example, the processor 120) may acquire only the image and may not activate the temperature sensor. In another embodiment, when the camera application is executed, the electronic device (for example, the processor 120) may automatically activate the temperature sensor. In one embodiment, in response to the temperature sensor being activated, the electronic device (for example, the processor 120) may start acquiring temperature information on the external object using the activated temperature sensor. In another embodiment, in response to a user input for starting acquiring temperature information being received, the electronic device (for example, the processor 120) may start acquiring temperature information on the external object using the activated temperature sensor. In still another embodiment, in response to a specified input (for example, an input for photographing) being received, the electronic device (for example, the processor 120) may start acquiring temperature information on the external object using the activated temperature sensor. However, this should not be considered as limiting.

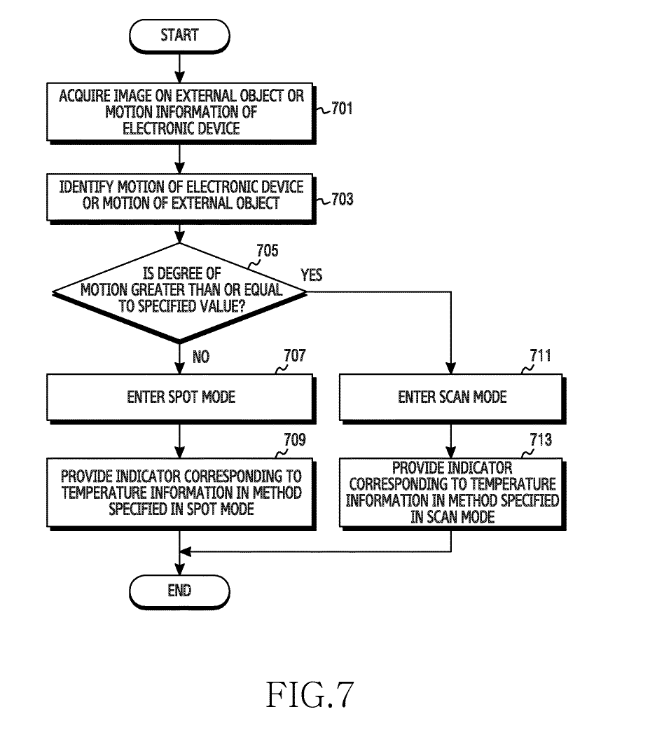

FIG. 7 illustrates a flowchart of a method for providing temperature information according to an exemplary embodiment of the present disclosure.

Referring to FIG. 7, since operations 701 to 703 are the same as or similar to at least a part of operations 501 to 503 of FIG. 5, a detailed description thereof is omitted.

In operation 705, the electronic device (for example, the processor 120) may determine whether the degree of the motion of the electronic device 101 or the degree of the motion of the external object is greater than or equal to a specified value. For example, the electronic device (for example, the processor 120) may determine whether a degree of a relative motion between the electronic device 101 and the external object, for example, a degree of a change in at least one of a motion speed, a motion acceleration, and a motion direction, is greater than or equal to the specified value or not.

In operation 707, when the degree of the motion of the electronic device 101 or the motion of the external object is less than the specified value in operation 705, the electronic device (for example, the processor 120) may enter a spot mode. In one embodiment, the spot mode may be a mode in which the electronic device 101 acquires temperature information in an inactive state.

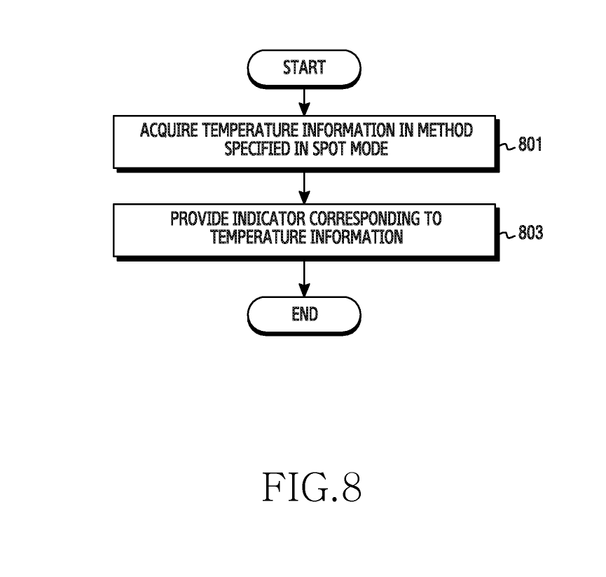

In operation 709, the electronic device (for example, the processor 120) may provide an indicator corresponding to the temperature information in a method specified in the spot mode. Operation 709 of providing the indicator corresponding to the temperature information in the method specified in the spot mode will be described in detail below with reference to FIGS. 8 to 11B.

In operation 711, when the degree of the motion of the electronic device 101 or the motion of the external object is greater than or equal to the specified value in operation 705, the electronic device 101 may enter a scan mode. In one embodiment, the scan mode may be a mode in which the electronic device 101 acquires temperature information in an active state. In one embodiment, the scan mode may be a mode in which the electronic device 101 acquires temperature information in an active state of the external object.

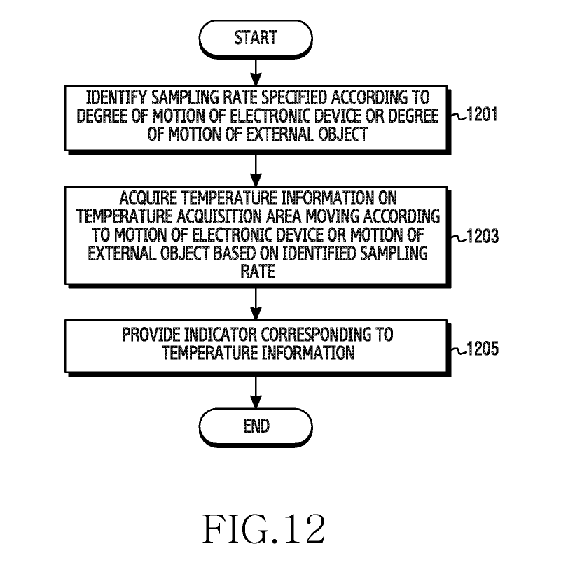

In operation 713, the electronic device (for example, the processor 120) may provide an indicator corresponding to the temperature information in a method specified in the scan mode. Operation 713 of providing the indicator corresponding to the temperature information in the method specified in the scan mode will be described in detail below with reference to FIGS. 12 to 16.

FIG. 8 illustrates a flowchart of a method for providing temperature information in the spot mode according to an exemplary embodiment of the present disclosure.

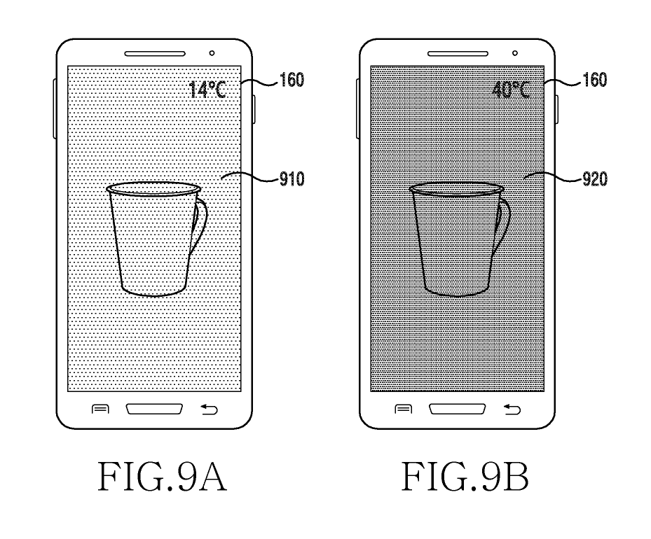

FIGS. 9A and 9B illustrate an example method for providing temperature information in the spot mode according to an exemplary embodiment.

Referring to FIGS. 8 and 9B, in operation 801, the electronic device (for example, the processor 120) may acquire temperature information in a method specified in the spot mode.

In one embodiment, in the spot mode, the electronic device (for example, the processor 120) may acquire temperature information at a sampling rate lower than a sampling rate in the scan mode. For example, in the spot mode, the electronic device (for example, the processor 120) may acquire temperature information on an external object (or an external object and a surrounding environment of the external object) at specified time intervals. The time interval specified in the spot mode may be longer than a time interval specified in the scan mode.

In one embodiment, in the spot mode, the electronic device (for example, the processor 120) may not calculate coordinates according to a degree of a motion using the motion sensor. For example, the spot mode may be a mode which is activated (or operated) when the degree of the motion of the electronic device 101 or the degree of the motion of the external object is small, and in the spot mode, the electronic device (for example, the processor 120) may not calculate coordinates according to the degree of the motion using the motion sensor. However, this should be considered as limiting. In one embodiment, the electronic device may not calculate coordinates according to the degree of the motion using the motion sensor, such that power consumption in the electronic device (for example, the processor 120) can be reduced.

In one embodiment, when a motion is measured using the motion sensor and the image sensor and the motion is less than a reference value, the motion may be calculated using only one sensor.

In operation 803, the electronic device (for example, the processor 120) may provide an indicator corresponding to the temperature information based on at least the acquired temperature information.

In one embodiment, the indicator may include a text indicating temperature information (for example, a number indicating temperature) or other images. For example, the other images may include a color image (or a thermal image) which is specified according to temperature information. In another example, the other images may include an icon, a graph, or an image including a text indicating temperature information, or a combination thereof. However, this should not be considered as limiting.

In one embodiment, the electronic device (for example, the processor 120) may generate an indicator corresponding to the temperature information which is acquired at specified time intervals, and display the generated indicator through the display 160 at specified time intervals (or in real time). For example, when temperature information acquired in a temperature acquisition area is changed or when the temperature of the external object is changed, the electronic device may generate an indicator reflecting the changed temperature of the external object. For example, as shown in FIG. 9A, when the temperature acquired in the temperature acquisition area is 14° C., the electronic device may display an indicator 910 of a color specified by 14° C. on the display 160. In another example, as shown in FIG. 9B, when the temperature acquired in the temperature acquisition area is 40° C., the electronic device may display an indicator 920 of a color specified by 40° C. on the display 160. In one embodiment, as shown in FIGS. 9A and 9B, the electronic device (for example, the processor 120) may control the display 160 to further display a text indicating temperature (for example, 14° C., 40° C.). However, this should not be considered as limiting.

In one embodiment, the electronic device (for example, the processor 120) may change at least a part of an image acquired through the camera 291 based on an attribute (for example, a color) corresponding to temperature information, and display the image. For example, when the temperature information is 14° C. as shown in FIG. 9A, the electronic device may change at least a part of the acquired image by applying the blue color and display the image. In another example, when the temperature information is 40° C. as shown in FIG. 9B, the electronic device may change at least a part of the acquired image by applying the red color and display the image. However, this should not be considered as limiting.

In one embodiment, in FIGS. 9A and 9B, the electronic device (for example, the processor 120) may superimpose (or overlay) the indicator including the color corresponding to the temperature information on a preview on the external object which is acquired through the camera 291 at specified time intervals. However, this should not be considered as limiting. For example, the electronic device (for example, the processor 120) may provide only the indicator indicating the temperature information acquired at specified time intervals without providing the preview of the external object.

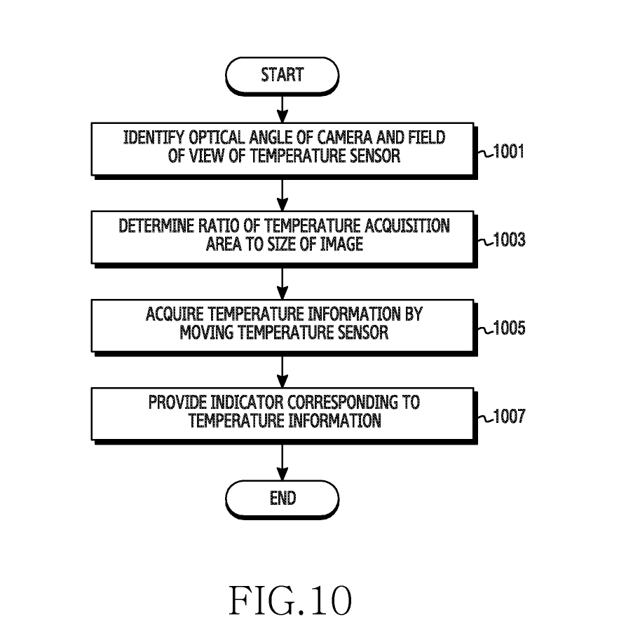

FIG. 10 illustrates a flowchart of a method for providing temperature information in the spot mode according to another exemplary embodiment of the present disclosure.

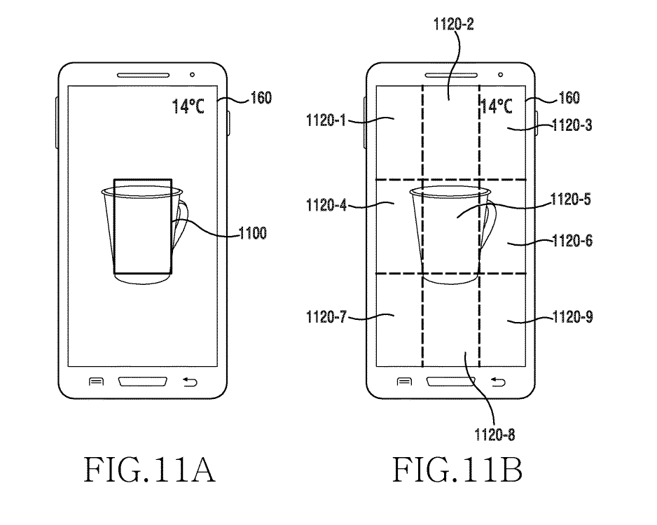

FIGS. 11A and 11B illustrate an example method for providing temperature information in the spot mode according to another exemplary embodiment of the present disclosure.

Referring to FIGS. 10 and 11B, in operation 1001, the electronic device (for example, the processor 120) may identify an optical angle of the camera 291 and a field of view of the temperature sensor which are currently set. For example, the electronic device (for example, the processor 120) may identify the optical angle of the camera 291 (or a focal distance of the camera 291) related to the size of an image acquired through the camera 291. The electronic device (for example, the processor 120) may identify the field of view of the temperature sensor related to a temperature acquisition area.

In operation 1003, the electronic device (for example, the processor 120) may determine a ratio of the temperature acquisition area to the size of the image displayed on the display 160 based on at least the optical angle of the camera and the field of view of the temperature sensor. For example, the electronic device (for example, the processor 120) may determine the ratio of the temperature acquisition area to the size of the image displayed on the display 160 based on a ratio of the field of view of the temperature sensor to the optical angle of the camera which is currently set.

For example, when the optical angle of the camera 291 of the electronic device (for example, the processor 120) is changed in FIG. 11A, the size of the image displayed on the display 160 may not be changed as a specified value. When the optical angle of the camera 291 of the electronic device (for example, the processor 120) is changed, the size of the external object displayed through an image and the size of the temperature acquisition area 1100 may be changed. For example, when the optical angle of the camera 291 of the electronic device (for example, the processor 120) increases, the size of the image may be maintained regardless of the optical angle of the camera 291 increasing, and the size of the external object displayed through the image and the size of the temperature acquisition area 1100 may be reduced at the same ratio. In another example, when the optical angle of the camera 291 of the electronic device (for example, the processor 120) is reduced, the size of the image may be maintained regardless of the optical angle of the camera 291 being reduced, and the size of the external object displayed through the image and the size of the temperature acquisition area 1100 may be magnified at the same ratio.

In operation 1005, the electronic device (for example, the processor 120) may acquire temperature information by moving the temperature sensor based on the ratio of the temperature acquisition area 1100 to the size of the image displayed on the display 160.

For example, when it is assumed that the ratio of the temperature acquisition area 1100 to the size of the image is 1/9 in FIG. 11B, the electronic device (for example, the processor 120) may continuously move the temperature sensor, such that the location of the temperature acquisition area of the temperature sensor matches the location of each of the small areas 1120-1 to 1120-9. When the location of the temperature acquisition area matches the location of each of the small areas 1120-1 to 1120-9, the electronic device (for example, the processor 120) may acquire temperature information from at least a part of the external object corresponding to the temperature acquisition area on the location of the small area matching the location of the temperature acquisition area. For example, when the temperature acquisition area overlaps the small area 1120-1 by moving the temperature sensor, the electronic device (for example, the processor 120) may acquire temperature information acquired in the temperature acquisition area overlapping the small area 1120-1. When the temperature acquisition area is moved from the area 1120-1 to the small area 1120-2 by moving the temperature sensor, the electronic device (for example, the processor 120) may acquire temperature information acquired in the temperature acquisition area overlapping the small area 1120-2. The electronic device (for example, the processor 120) may acquire temperature information on the other small areas 1120-3 to 1120-9 in the same method. However, this should not be considered as limiting.

In another example, the electronic device (for example, the processor 120) may acquire temperature information on the small areas by moving the temperature sensor according to a sampling rate. In one embodiment, the electronic device (for example, the processor 120) may adjust the sampling rate according to the ratio of the temperature acquisition area to the size of the image. For example, as the ratio of the temperature acquisition area to the size of the image is smaller, the electronic device (for example, the processor 120) may acquire temperature information on more small areas. As the ratio of the temperature acquisition area to the size of the image is smaller, the electronic device (for example, the processor 120) may adjust the sampling rate to a higher sampling rate. In one embodiment, the electronic device (for example, the processor 120) may adjust a degree of movement of the temperature sensor (for example, a movement speed, a movement distance, or rotation) so as to overlap the temperature acquisition area of the temperature sensor with each of the small areas according to the adjusted sampling rate. For example, as the sampling rate is higher, the degree of the movement of the temperature sensor may be adjusted smaller. However, this should not be considered as limiting.

In one embodiment, the electronic device (for example, the processor 120) may further include a motor for moving the temperature sensor. However, the configuration of moving only the temperature sensor without moving the electronic device 101 is not limited to this.

In operation 1007, the electronic device (for example, the processor 120) may provide an indicator corresponding to the temperature information.

In one embodiment, the electronic device (for example, the processor 120) may acquire a plurality of pieces of temperature information by moving the temperature sensor and generate indicators indicating the acquired plurality of pieces of temperature information. For example, the electronic device (for example, the processor 120) may generate indicators indicating temperature information mapped onto the entirety of the coordinates of the locations to which the temperature acquisition area is moved by combining the pieces of temperature information which are mapped onto coordinates information of the locations to which the temperature sensor is moved and are stored.

In one embodiment, the indicator may include a text indicating temperature information (for example, a number indicating temperature) or other images. For example, the other images may include a color image (or a thermal image) which is specified according to temperature information. In another example, the other images may include an icon, a graph, or an image including a text indicating temperature information, or a combination thereof. However, this should not be considered as limiting.

In one embodiment, the electronic device (for example, the processor 120) may generate an indicator corresponding to temperature information which is acquired in real time according to a movement of the temperature sensor, and display the indicator through the display 160. For example, when the electronic device (for example, the processor 120) acquires temperature information on the small area 1120-1, the small area 1120-2, and the small area 1120-3 while moving the temperature sensor in FIG. 11B, the electronic device (for example, the processor 120) may generate indicators (for example, color images) corresponding to the temperature information on the small area 1120-1, the small area 1120-2, and the small area 1120-3, and may superimpose the indicators on the previews of the small area 1120-1, the small area 1120-2, and the small area 1120-3 and display the indicators. In the state in which the indicators corresponding to the temperature information on the small area 1120-1, the small area 1120-2, and the small area 1120-3 and the previews are displayed, when the location of the temperature acquisition area 1100 of the temperature sensor is moved from the location of the small area 1120-3 to the small area 1120-4, the electronic device (for example, the processor 120) may generate indicators (for example, color images) corresponding to the temperature information on the small areas 1120-1, the small area 1120-2, the small area 1120-3, and the small area 1120-4, and superimpose the indicators on the previews of the small area 1120-1, the small area 1120-2, the small area 1120-3, and the small area 1120-4 and display the indicators in real time.

In one embodiment, the electronic device (for example, the processor 120) may superimpose the image photographed through the camera 291 and the indicator corresponding to the temperature information, and may display the image and the indicator. In another embodiment, the electronic device (for example, the processor 120) may display only the indicator corresponding to the temperature information. However, this should not be considered as limiting.

FIG. 12 illustrates a flowchart of a method for providing temperature information in the scan mode according to an exemplary embodiment of the present disclosure.

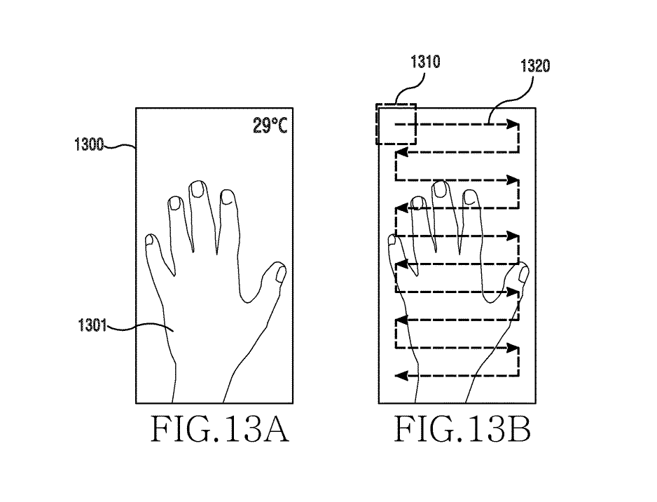

FIGS. 13 to 16 illustrate an example method for providing temperature information in the scan mode according to an exemplary embodiment of the present disclosure.

Referring to FIGS. 12 to 16, in operation 1201, the electronic device (for example, the processor 120) may identify a sampling rate which is adjusted based on at least a degree of a motion of the electronic device 101 or a degree of a motion of an external object.

In one embodiment, the electronic device (for example, the processor 120) may acquire information on the motion of the electronic device 101 using the motion sensor, for example, at least one of the acceleration sensor 240E, the gyro sensor 240B, the geomagnetic sensor, and the magnetic sensor 240D. In one embodiment, the electronic device (for example, the processor 120) may acquire coordinates information according to the motion of the electronic device 101 (for example, coordinates information indicating the location and the direction of the electronic device 101) using the motion sensor.

In one embodiment, the electronic device (for example, the processor 120) may identify the degree of the motion of the electronic device 101 based on a degree of a change in the coordinates information acquired at specified intervals.

In another embodiment, the electronic device (for example, the processor 120) may acquire an image using the camera 291 at specified intervals, and may identify the degree of the motion of the electronic device 101 or the motion of the external object (or a degree of a relative motion between the electronic device 101 and the external device) based on a degree of a change in the acquired image.

In one embodiment, the electronic device (for example, the processor 120) may identify a sampling rate which is specified according to the degree of the motion of the electronic device 101 or the motion of the external object. For example, the electronic device (for example, the processor 120) may store the sampling rate which is mapped onto every degree of the motion of the electronic device 101 or the motion of the external object, and may identify the sampling rate mapped onto the identified degree of the motion of the electronic device 101 or the motion of the external object.

In one embodiment, the electronic device (for example, the processor 120) may further perform an operation of identifying the sampling rate which is adjusted based on at least a degree of a change in temperature information on the external object which is acquired through the temperature sensor. For example, the electronic device (for example, the processor 120) may store the sampling rate which is mapped onto every degree of change in temperature of the external object, and may identify the sampling rate which is mapped onto the identified degree of the change in the temperature.

In operation 1203, the electronic device (for example, the processor 120) may acquire temperature information on a temperature acquisition area which is moved according to the motion of the electronic device 101 or the motion of the external object based on the identified sampling rate.

For example, FIG. 13A illustrates an image 1300 displaying an image of an external object 1301, which is a target for acquiring temperature information. In one embodiment, when the user intends to acquire temperature information in the same area as the area in which the image 1300 of FIG. 13A is acquired, the user may move the electronic device 101 such that a temperature acquisition area 1310 is moved following the trace of an arrow 1320 as shown in FIG. 13B. For example, when the user moves the electronic device 101, the temperature acquisition area 1310 may be moved according to the motion of the electronic device 101. When the temperature acquisition area is moved, the electronic device (for example, the processor 120) may acquire temperature information on at least a part of the external object included in the temperature acquisition area 1310 at a sampling rate which is adjusted according to the degree of the motion of the electronic device 101. However, this should not be considered as limiting. For example, although FIG. 13B illustrates an example of acquiring temperature information according to the motion of the electronic device 101, the method for acquiring temperature according to various exemplary embodiments of the present disclosure may be equally applied when the electronic device 101 is in the inactive state and the external object 1301 is moved or when both the electronic device 101 and the external object are moved.

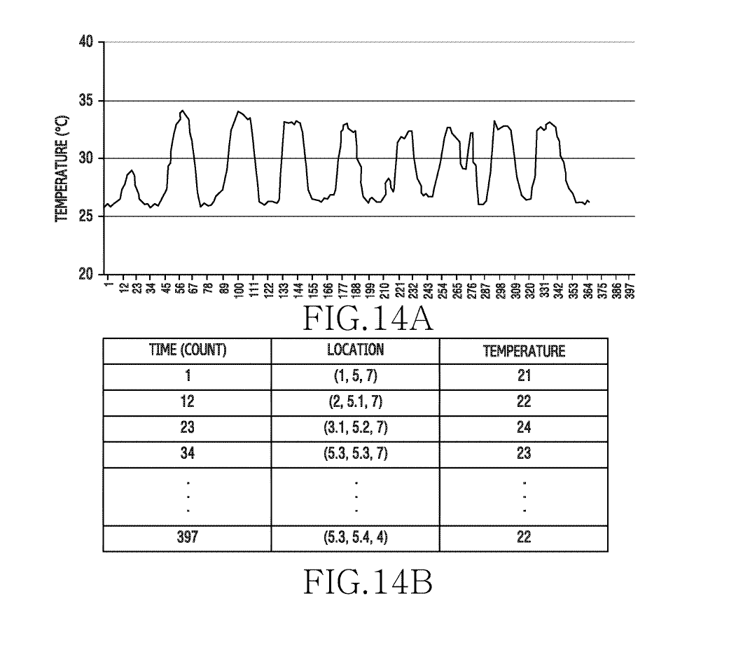

In one embodiment, the electronic device (for example, the processor 120) may store acquired temperature information at specified time intervals (or according to a sampling rate). For example, as shown in FIG. 14A, the electronic device (for example, the processor 120) may acquire temperature information at specified time (or count) intervals (or a sampling rate), and store the acquired temperature information. In another example, as shown in FIG. 14B, when the electronic device (for example, the processor 120) or the external object is moved, the electronic device (for example, the processor 120) may acquire location (or coordinates) information according to a relative motion between the electronic device (for example, the processor 120) and the external object at specified time intervals, and may map temperature information acquired in a corresponding location onto the location information and store the mapped information. However, this should not be considered as limiting.

In operation 1205, the electronic device (for example, the processor 120) may provide an indicator corresponding to the temperature information.

In one embodiment, the electronic device (for example, the processor 120) may generate an indicator indicating the temperature information based on at least the information on the motion of the electronic device 101 or the motion of the external object which is acquired using the motion sensor or the camera 291 (or information on the relative motion between the electronic device 101 and the external object). For example, the electronic device (for example, the processor 120) may generate indicators indicating temperature information mapped onto the entirety of the coordinates of locations to which the temperature acquisition area is moved, by combining temperature information which is mapped onto each of coordinates information of locations to which the temperature acquisition area is moved according to the relative motion between the electronic device 101 and the external object, and is stored.

In one embodiment, the indicator may include a text indicating temperature information (for example, a number indicating temperature) or other images. For example, the other images may include a color image (or a thermal image) which is specified according to temperature information. In another example, the other images may include an icon, a graph, or an image including a text indicating temperature information, or a combination thereof. However, this should not be considered as limiting.

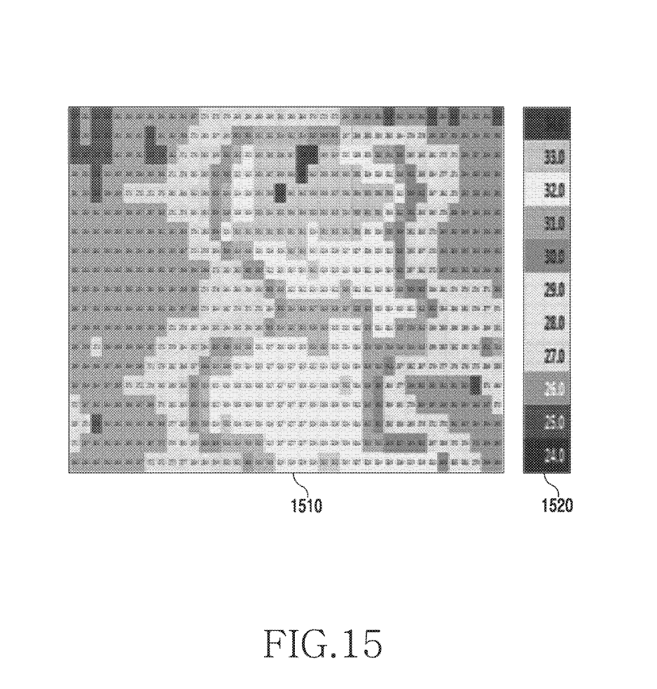

For example, as shown in FIG. 15, the electronic device (for example, the processor 120) may generate an indicator 1510 in the form of an image including a number and a color corresponding to temperature information in every location (or area) of a specified number of pixels. In one embodiment, the electronic device (for example, the processor 120) may further include a display 1520 for informing temperature corresponding to colors as shown in FIG. 15.

In one embodiment, the electronic device (for example, the processor 120) may generate an indicator corresponding to temperature information which is acquired at specified intervals, and display the generated indicator through the display 160 at specified intervals. For example, the electronic device may provide an indicator indicating temperature information which is acquired in the temperature acquisition area moving according to the motion of the electronic device 101 or the motion of the external object in real time.

In one embodiment, when the indicator indicating the temperature information acquired in real time is provided, the electronic device (for example, the processor 120) may superimpose (overlay) a preview on the external object which is acquired through the camera 291 in real time on the indicator indicating the temperature information, and provide the preview and the indicator. For example, as shown in FIG. 13B, while the temperature acquisition area 1310 is moved following the trace of the arrow 1320 according to the motion of the electronic device 101, the electronic device (for example, the processor 120) may generate an indicator (for example, a color image) corresponding to temperature information based on at least temperature information acquired in an area corresponding to the moving temperature acquisition area 1310, and superimpose the indicator on a preview of the area corresponding to the temperature acquisition area 1310 and display the indicator and the preview in real time. In another embodiment, the electronic device (for example, the processor 120) may provide only the indicator indicating the temperature information acquired in real time without providing the preview on the external object.

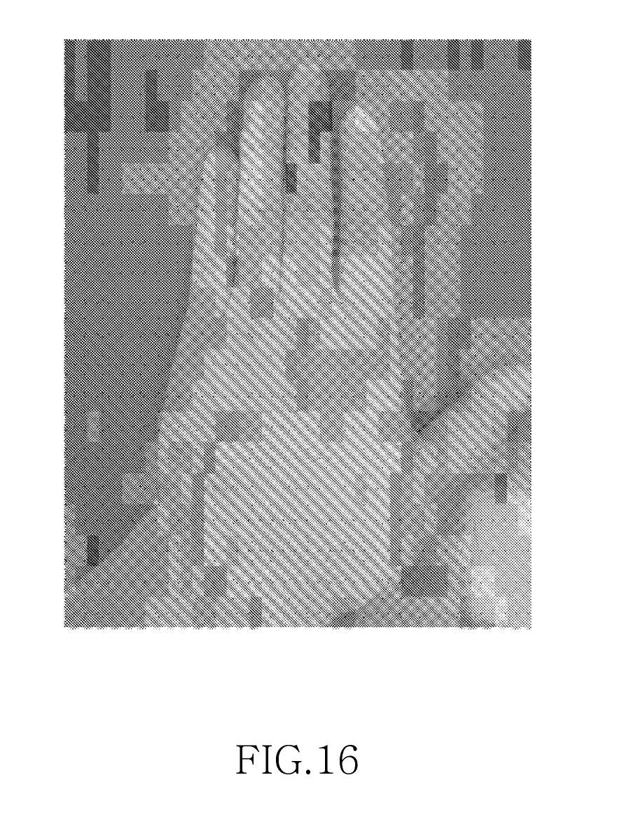

In one embodiment, when a reference image is acquired, the electronic device (for example, the processor 120) may provide an indicator corresponding to (or mapped onto) the reference image. For example, the electronic device (for example, the processor 120) may provide the indicator corresponding to the reference image by combining temperature information acquired in an area corresponding to the reference image, for example, an area included in a photographing area in which the reference image is acquired in the area in which temperature is acquired (or an area overlapping the photographing area in which the reference image is acquired). For example, when the image 1300 shown in FIG. 13A is acquired (or photographed) as a reference image, the electronic device (for example, the processor 120) may superimpose an indicator corresponding to temperature information on the reference image and display the indicator and the reference image as shown in FIG. 16. However, this should not be considered as limiting.

In one embodiment, the electronic device (for example, the processor 120) may provide only the indicator corresponding to the reference image as shown in FIG. 15, or provide the reference image and the indicator corresponding to the reference image and superimposed on the reference image as shown in FIG. 16, selectively, based on a user's input. However, this should not be considered as limiting.

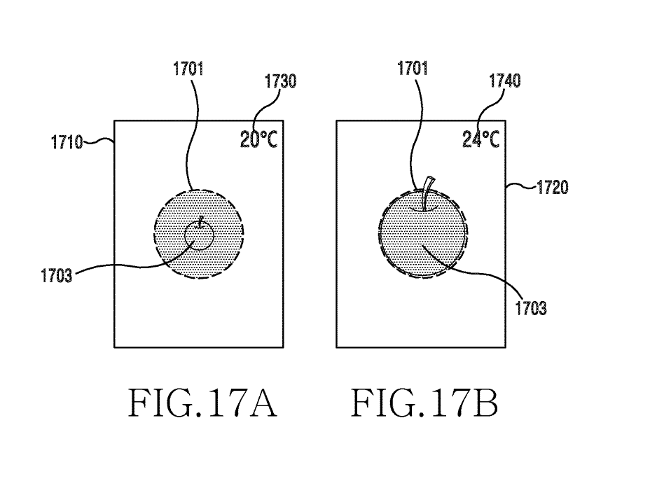

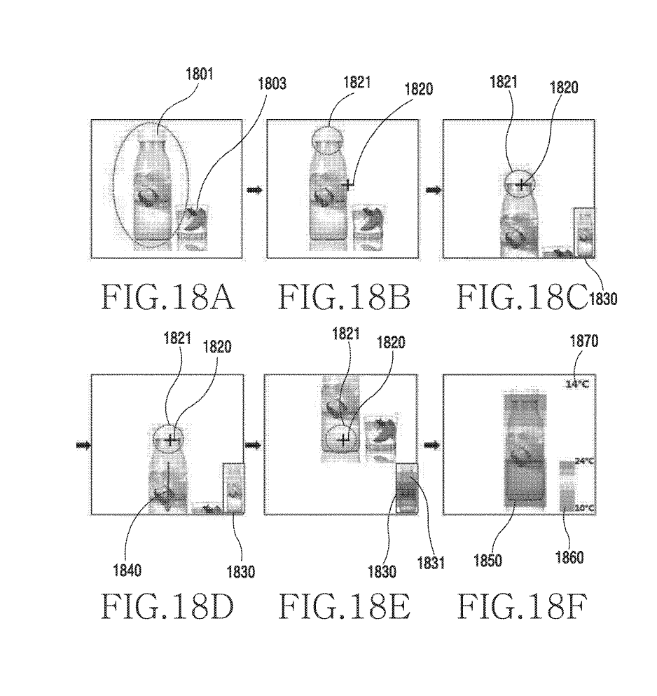

FIGS. 17A to 18F illustrate an example method for providing a guide for acquiring temperature information according to an exemplary embodiment of the present disclosure.

In one embodiment, when a user input for acquiring temperature information is received, the electronic device (for example, the processor 120) may display an external object to be photographed using the camera 291 and a display indicating a temperature acquisition area through the display 160. For example, as shown in FIG. 17A, the electronic device (for example, the processor 120) may display an image 1710 including an external object 1703 to be photographed and a display 1701 shown by a dashed circle and indicating a temperature acquisition area through the display 160. In one embodiment, the electronic device (for example, the processor 120) may further display an indicator 1730, 1740 indicating temperature information acquired in the temperature acquisition area.

In one embodiment, the electronic device (for example, the processor 120) may calculate the shape and the size (for example, an area or the like) of the external object 1703, which is a target for acquiring temperature. In one embodiment, when there are a plurality of external objects as targets for acquiring temperature, the electronic device (for example, the processor 120) may receive an input of selecting an object for acquiring temperature from the user, and calculate the shape and the size of the selected external object 1703. However, this should not be considered as limiting. For example, when there is a plurality of external objects as targets for acquiring temperature, the electronic device (for example, the processor 120) may calculate the shapes and the sizes of the plurality of external objects.

In one embodiment, the electronic device (for example, the processor 120) may compare the shape and the size of the temperature acquisition area and the shape and the size of the external object 1703 which is a target for acquiring temperature information. In one embodiment, as a result of the comparing, it may be determined that there is a difference between the shape and the size of the temperature acquisition area and the shape and the size of the external object 1703 which is a target for acquiring temperature information. In this case, the electronic device (for example, the processor 120) may provide a guide for guiding the user to move the electronic device (for example, the processor 120) such that the difference between the shape and the size of the temperature acquisition area and the shape and the size of the external object, which is a target for acquiring temperature information, falls within a threshold range.

For example, FIG. 17A illustrates a case in which the shape of the temperature acquisition area and the shape of the external object 1703 are circular, and the size of the temperature acquisition area is larger than the size of the external object 1703. The electronic device (for example, the processor 120) may display a guide for guiding the user to place the electronic device (for example, the processor 120) at a distance close to the external object, such that the size of the temperature acquisition area and the size of the external object 1703 match each other or the difference between the size of the temperature acquisition area and the size of the external object 1703 falls within a threshold range as shown in an image 1720 of FIG. 17B. In one embodiment, the guide may be displayed as a text or a sign like an arrow although not illustrated in FIGS. 17A and 17B. However, this should not be considered as limiting.

In another example, FIGS. 18A to 18F illustrate an example case in which the shape of a temperature acquisition area and the shape and the size of an external object are different.

In one embodiment, in FIG. 18A, an external object 1801 may be selected from among a plurality of external objects 1801, 1803 as a target for acquiring temperature. For example, the electronic device (for example, the processor 120) may select the external object 1801 as a target for acquiring temperature from among the plurality of external objects 1801, 1803 based on at least a user′ selection input. However, this should not be considered as limiting.

In one embodiment, when the external object 1801 is selected as a target for acquiring temperature, the electronic device (for example, the processor 120) may display a guide informing an initial position for acquiring temperature information on the selected external object 1801. For example, as shown in FIG. 18B, the electronic device (for example, the processor 120) may display a guide 1821 informing a position for starting acquiring temperature information on the selected external object 1801. In one embodiment, the electronic device (for example, the processor 120) may further display a display 1820 indicating a point corresponding to the center of the temperature acquisition area of the temperature sensor. However, this should not be considered as limiting.

In one embodiment, as shown in FIG. 18C, when the display 1820 indicating the point corresponding the center of the temperature acquisition area is included in the guide 1821 according to the motion of the electronic device 101 by the user, the electronic device (for example, the processor 120) may start acquiring temperature through the temperature sensor. However, this should not be considered as limiting. In one embodiment, as shown in FIG. 18C, when the electronic device (for example, the processor 120) starts acquiring temperature, the electronic device may further display a reduced image 1830 of a reference image (or an image acquired in advance regarding the external object which is a target for acquiring temperature).

In one embodiment, as shown in FIG. 18D, the electronic device (for example, the processor 120) may further display a guide 1840 for guiding a motion of the electronic device 101 to acquire (or scan) an image.

In one embodiment, as shown in FIG. 18E, the electronic device (for example, the processor 120) may display temperature information which is acquired according to the motion of the electronic device 101 on the image 1830. For example, the electronic device (for example, the processor 120) may superimpose an indicator 1831 corresponding to temperature information acquired in the temperature acquisition area at specified time intervals (or a sampling rate) on the image 1830, and display the indicator 1831.

In one embodiment, as shown in FIG. 18F, when it is determined that the acquisition of the temperature of the external object to be photographed is completed or the temperature acquisition operation is completed by a user input, the electronic device (for example, the processor 120) may display an indicator 1850 corresponding to the temperature information. In one embodiment, FIG. 18F illustrates the indicator 1850 which is superimposed on the reference image. However, this should not be considered as limiting. In one embodiment, the electronic device (for example, the processor 120) may further display a display 1860 for guiding temperature corresponding to a color included in the indicator 1850. In one embodiment, the electronic device (for example, the processor 120) may further display an indicator 1870 (for example, a number indicating temperature) indicating the temperature information acquired in the temperature acquisition area.

According to various exemplary embodiments of the present disclosure, a method includes: identifying a motion of an electronic device or a motion of an external object using an image which is acquired through an image sensor, or a motion sensor; when the motion falls within a specified range, acquiring temperature information on the external object in a first method using a temperature sensor for acquiring the temperature information on the external object; when the motion falls within another specified range, acquiring the temperature information in a second method using the temperature sensor for acquiring the temperature information on the external object; and providing an indicator corresponding to the temperature information through a display functionally connected with the electronic device.

In one embodiment, the temperature sensor and the image sensor may be implemented by using a single module.

In one embodiment, the temperature sensor may acquire temperature information within a view area corresponding to the image sensor.

In one embodiment, the image may include a first image and a second image, and the method may further include identifying the motion based on a displacement of a pixel area corresponding to at least a part of the identified external object using the first image and the second image.

In one embodiment, the method may further include acquiring, by the first method, the temperature information using a first sampling rate, and acquiring, by the second method, the temperature information using a second sampling rate.

In one embodiment, the method may further include changing the first sampling rate or the second sampling rate based on a change in the temperature information.

In one embodiment, the second sampling rate may include a third sampling rate and a fourth sampling rate, and the method may further include, when the motion is a first motion, changing the second sampling rate to the third sampling rate, and, when the motion is a second motion, changing the second sampling rate to the fourth sampling rate.

In one embodiment, the indicator may include a text indicating the temperature information or other images.

In one embodiment, the other images may include a color image corresponding to the temperature information.

In one embodiment, the method may further include displaying at least a part of the image and the indicator all together.

In one embodiment, the method may further include superimposing and displaying the other images on an area in the image corresponding to the external object.

In one embodiment, the method may further include changing at least a part of the image based on an attribute corresponding to the temperature information and displaying the image.

In one embodiment, the external object may include a first part and a second part, and the method may further include acquiring a first temperature on the first part when the electronic device is located on a first location, and acquiring a second temperature on the second part when the electronic device is located on a second location.

In one embodiment, the other images may include a first area corresponding to the first part and a second area corresponding to the second part, and the method may further include displaying a first color corresponding to the first temperature on the first area, and displaying a second color corresponding to the second temperature on the second area.

In one embodiment, the method may further include determining the first area based on the first location and determining the second area based on the second location.

In one embodiment, the method may further include acquiring the temperature information by moving the temperature sensor when the temperature information is acquired in the first method.

In one embodiment, the method may further include displaying a guide for guiding to acquire temperature information on the external object through the display.

The method for acquiring temperature information and the electronic device supporting the same according various exemplary embodiments of the present disclosure acquire temperature information adaptively according to a degree of a motion of the electronic device, which includes a small number of temperature sensors (for example, one temperature sensor), or a degree of a motion of an external object, or a degree of a change in temperature of the external object, and provide exact temperature information in various methods based on the acquired temperature information.

In addition, the structure of data used in the above-described embodiments may be recorded on a computer-readable recording medium through various means. The computer-readable recording medium includes a storage medium such as a magnetic storage medium (for example, a read only memory (ROM), a floppy disk, a hard disk, or the like) or an optical reading medium (for example, a compact disc-ROM (CD-ROM), a digital versatile disc (DVD)).

In one embodiment, a storage medium storing instructions may include a computer-readable storage device which has a program recorded thereon, for executing at least one operation. The instructions may be configured to allow at least one processor to perform the at least one operation when being executed by the at least one processor, and the at least one operation may include: identifying a motion of an electronic device or a motion of an external object using an image which is acquired through an image sensor, or a motion sensor; when the motion falls within a specified range, acquiring temperature information on the external object in a first method using a temperature sensor for acquiring the temperature information on the external object; when the motion falls within another specified range, acquiring the temperature information in a second method using the temperature sensor for acquiring the temperature information on the external object; and providing an indicator corresponding to the temperature information through a display functionally connected with the electronic device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a motion sensor;
a temperature sensor configured to acquire temperature information on an external object;
an image sensor configured to acquire an image on the external object; and
a processor configured to:
identify a motion of the electronic device and a motion of the external object using at least one of the motion sensor or the image;
when the motion falls within a specified range, acquire the temperature information in a first scheme;
when the motion falls within another specified range, acquire the temperature information in a second scheme; and
provide an indicator corresponding to the temperature information through a display functionally connected with the electronic device.

2. The electronic device of claim 1, wherein the temperature sensor and the image sensor are implemented using a single circuitry.

3. The electronic device of claim 1, wherein the temperature sensor is configured to acquire temperature information within a view area corresponding to the image sensor.

4. The electronic device of claim 1, wherein the image comprises a first image and a second image, and
wherein the processor is further configured to identify the motion based on a displacement of a pixel area corresponding to at least a part of the external object using the first image and the second image.

5. The electronic device of claim 1, wherein the processor is further configured to:
perform the first scheme acquiring the temperature information using a first sampling rate and the second scheme acquiring the temperature information using a second sampling rate.

6. The electronic device of claim 5, wherein the processor is further configured to change at least one of the first sampling rate or the second sampling rate based on a change in the temperature information.

7. The electronic device of claim 5, wherein the second sampling rate comprises a third sampling rate and a fourth sampling rate, and
wherein the processor is further configured to:
when the motion is a first motion, change the second sampling rate to the third sampling rate; and
when the motion is a second motion, change the second sampling rate to the fourth sampling rate.

8. The electronic device of claim 1, wherein the indicator comprises a text indicating at least one of the temperature information or other images.

9. The electronic device of claim 8, wherein the other images comprise a color image corresponding to the temperature information.

10. The electronic device of claim 1, wherein the processor is further configured to display at least a part of the image and the indicator.

11. A method comprising:
identifying at least one of a motion of an electronic device or a motion of an external object using an image that is acquired through at least one of an image sensor or a motion sensor;
when the motion falls within a specified range, acquiring temperature information on the external object in a first scheme using a temperature sensor for acquiring the temperature information on the external object;
when the motion falls within another specified range, acquiring the temperature information in a second scheme using the temperature sensor for acquiring the temperature information on the external object; and
providing an indicator corresponding to the temperature information through a display functionally connected with the electronic device.

12. The method of claim 11, wherein the temperature sensor and the image sensor are implemented using a single circuitry.

13. The method of claim 11, wherein the temperature sensor is configured to acquire temperature information within a view area corresponding to the image sensor.

14. The method of claim 11, wherein the image comprises a first image and a second image, and
wherein the method further comprises identifying the motion based on a displacement of a pixel area corresponding to at least a part of the external object using the first image and the second image.

15. The method of claim 11, further comprising acquiring, by the first scheme, the temperature information using a first sampling rate, and acquiring, by the second scheme, the temperature information using a second sampling rate.

16. The method of claim 15, further comprising changing at least one of the first sampling rate or the second sampling rate based on a change in the temperature information.

17. The method of claim 15, wherein the second sampling rate comprises a third sampling rate and a fourth sampling rate, and
wherein the method further comprises:
when the motion is a first motion, changing the second sampling rate to the third sampling rate; and
when the motion is a second motion, changing the second sampling rate to the fourth sampling rate.

18. The method of claim 11, wherein the indicator comprises a text indicating at least one of the temperature information or other images.

19. The method of claim 18, wherein the other images comprise a color image corresponding to the temperature information.

20. The method of claim 11, further comprising displaying at least a part of the image and the indicator.
